(19) United States
(12) Patent Application Publication
(10) Pub. No.: US 2006/0188540 A1
(43) Pub. Date: Aug. 24, 2006

(54) Insect attractant composition and trap containing same

(76) Inventor: Peter Henry Scott, Southport (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/357,035

(22) Filed: Feb. 21, 2006

(30) Foreign Application Priority Data
Feb. 21, 2005 (AU) 2005200757

(51) Int. Cl. A01N 25/08; A01N 37/00

(52) U.S. Cl. 424/410; 514/557

(57) ABSTRACT

An insect attractant composition including a short chain carboxylic acid, a short chain alcohol, a surfactant and water.

### FIELD OF THE INVENTION

The present invention relates to insect traps and in particular to an attractant composition used in insect traps.

### BACKGROUND ART

The prior art contains an extensive array of insect traps. A common method is to use ultraviolet light to attract insects to a high voltage electrocution grid, or to an adhesive trapping board. Electrocution grids and their associated electrical components involve a high capital cost, while adhesive boards have a limited effective life, are expensive and need to be replaced frequently.

Chemical attractants are also known. For example, U.S. Pat. No. 6,543,181 teaches a fruit fly attractant composition comprising: a volatile short chain carboxylic acid, a volatile short chain alcohol, a volatile aryl substituted alcohol, and a nitrogen compound. This document also describes other insect attractants and a portion of the Background Art section of that document is reproduced below verbatim.

“In U.S. Pat. No. 5,490,349, issued Feb. 13, 1996, to Muramatsu, there is disclosed an insect trap which contains a liquid insect attractant which is fully enclosed so that the trap may be shipped without spillage or loss. The trap includes an enclosure which provides a funnel shaped portion terminating in a substantially translucent nipple. The insect trap may be commissioned into service by piercing the nipple thereby creating an inlet into the interior chamber through which insects will be drawn by the liquid attractant. The nipple is formed by a thermal process so that the walls of the inlet are drawn thin creating translucent walls which form a bright spot of light larger than the inlet's opening, thereby making it difficult for trapped insects to find the opening and gain freedom. Except for the terminal portions of the inlet, the enclosure is substantially opaque so that the contents of the insect trap are not visible to the public.

There exists a commercial product that is believed to be an embodiment of the above U.S. Pat. No. 5,490,349, which consists of a small plastic vessel-type trap with a small hole in the top, and named “Natural Catch®0 Plus Fruit Fly Trap”. The liquid attractant used in the trap is believed to be primarily vinegar, which is referred to hereinafter as “Anderson's solution.”

In U.S. Pat. No. 5,464,626, issued Nov. 7, 1995, to W. Warren, et al., there is disclosed a method for attracting the insect species Culex nigripalpus, Aedes atlanticus, Culex salinarius, Aedes vexans, Culex spp., Simulium spp., Psorofeta ferox, Aedes infirmatus, Drosophila melanogaster, Coccinellidae, Anopheles crucians, Psoroferia columbiae, Culicoides spp. and Aedes spp., using a compound having a dimethyl substituted oxymethyl cyclohexane derivative structure. This attractant finds utility primarily as a bait enhancer for acute toxins and/or trapping devices.

In U.S. Pat. No. 5,008,107, issued Apr. 16, 1991, to C. Warren, et al., there is disclosed a novel attractant composition for use with synanthropic flies (the so-called ‘filth flies’ such as the house fly) which includes indole and skatole, a pheromone, trimethylamine hydrochloride, and a suitable carrier.

In U.S. Pat. No. 6,106,821, issued Aug. 22, 2000, to Baker et al., there is disclosed (house) fly attractant compositions that comprise at least one volatile short chain carboxylic acid, at least one organic sulfide, and at least one nitrogen heterocycle. In a preferred embodiment the composition additionally comprises at least one ammonia-releasing compound. In a particularly preferred example, the composition is preparable by combining, for example, the carboxylic acid, the organic sulfide and the nitrogen heterocycle. The invention also relates to an insect trap comprising a means for retaining flies and an insect attractant composition of this invention. The trap is useful in commercial, residential and livestock facilities.”

As should be relatively clear in light of the number and variety of the attractants available, not all attractants act on a broad spectrum of insects and some are not effective at all. According to the invention defined in U.S. Pat. No. 6,543,181, the attractant is formed of three volatile components and is designed to vapourise at ambient temperature. This leads to evaporation of the liquid and the need to re-fill the trap.

Further the nitrogen compound or nitrogen heterocycle compound used in the prior art composition is chosen to add a distinctive odour to the composition which is lessened by the use of the aryl substituted alcohol, so that humans are less likely to detect the scent but which insects are still attracted to.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to an insect attractant, which may at least partially overcome at least one of the abovementioned disadvantages or provide the consumer with a useful or commercial choice.

In one form, the invention resides in an insect attractant composition consisting essentially of a short chain carboxylic acid and a short chain alcohol;

In an alternative form, the invention resides in an insect attractant composition including a short chain carboxylic acid, and a short chain alcohol.

According to a particularly preferred embodiment of the invention, the short chain alcohol will be octanol or C₈ alcohol. Other suitable alcohols include, for example, methanol, isopropanol, propanol, butanol, pentanol, hexanol, and cis-3-hexanol.

According to a preferred embodiment of the invention, the short chain carboxylic acids include carboxylic acids having 1-8 carbon atoms and preferred short chain carboxylic acids include those carboxylic acids having 2-5 carbon atoms. These include formic acid, acetic acid, lactic acid, propanoic acid, butanoic acid, hexanoic acid, heptanoic acid, octanoic acid, and benzoic acid. Also, in a preferred embodiment the short chain carboxylic acids can be either straight or methyl branched aliphatic carboxylic acids. A particularly preferred carboxylic acid is lactic acid or C₃H₆O₃.

According to the invention, virtually any surfactant may be used. Whilst not wishing to be limited by theory, the inventor believes that the surfactant in dishwashing detergent for example may contribute to the invention by lowering the surface tension of the water in the composition and allow the components increased miscibility.

In a more particular form, the invention resides in an insect attractant composition including
0.01% to 20% of C₄ to C₁₀ alcohol,
0.01% to 20% of C₃H₆O₃,
0.01% to 20% of surfactant and
40% to 99.97% water.

In a particularly preferred form, the invention resides in an insect attractant composition including approximately
2% of C₈ alcohol,
2% of lactic acid C₃H₆O₃,
2% of surfactant
94% water+trace amount of dye.

The dye is preferably a simple dye such as food colouring or similar. The dye is typically used to allow the otherwise clear liquid of the composition to be easily seen.

The composition above may be used as described, but typically it will be further diluted prior to placing the attractant composition into an insect trap.

The insect attractant composition is generally used in an insect trap to attract insects into the trap. The preferred form of trap has a bucket-like configuration. The trap may include multiple attractants including the attractant composition of the invention which together contribute to a controlled environment with in the trap, for example:
Movement with Light—one or more spectrum lights may emit a moving wavelength of light.
UV Light(s)—A blue UV light may be provided to attract most species of mosquitoes. The lights may be provided to flash intermittently.
Colour—The dark colour of the Insect trap may acts as a natural attractant. A particularly preferred colour may be blue or green.
Moisture and Scent—The insect attractant may typically emulate a mammal scent and may produce moisture which replaces the expensive CO2 gas attractant.

Once the insects are drawn into the chamber, an in-built fan forces the insects to their death by drowning in the non-toxic environmentally friendly insect attractant liquid.

The insect trap will typically be circular, and have a removable portion at a lower portion of the trap to contain the insect attractant. The removable portion may be a drawer or similar, or alternatively, an upper annular portion of the trap to which the lid attaches (an annular sidewall portion) may be removable from a lower, bucket-like portion. One or more mounting tags may be provided on the upper annular portion to engage respective openings provided on the lower portion of the trap. Generally a plurality of mounting tags spaced about the periphery of the trap will be provided. The mounting tags may detachably lock the upper annular portion of the trap to the lower portion of the trap. The locking action typically involves the insertion of the mounting tags into the respective openings and partially rotating the upper annular portion relative to the lower portion of the trap.

The trap may also have a removable lid. The side wall of the trap will preferably be provided with at least one and preferably multiple openings to allow the insects into the interior of the trap. The openings may take the form of slatted openings. The side walls of the trap may be provided with bracing means to help the upper annular portion maintain its shape and to assist with the correct location of the mounting tags.

### BRIEF DESCRIPTION OF THE DRAWINGS

Various embodiments of the invention will be described with reference to the following drawings, in which:

FIG. 1 is a side elevation view of an insect trap in which the composition according to a preferred embodiment will generally be used.

FIG. 2 is a view from above of the insect trap illustrated in FIG. 1 with the lid removed and the lower portion removed.

FIG. 3 is a side elevation view of the insect trap illustrated in FIG. 2.

FIG. 4 is a top view of the lid of the trap illustrated n FIG. 1.

FIG. 5 is a side view of the lid illustrated in FIG. 4.

FIG. 6 is a side elevation view of the lower removable portion of the insect trap illustrated in FIG. 1.

FIG. 7 is a top view of the lower removable portion of the insect trap illustrated in FIG. 6.

FIG. 8 is a side elevation view of a control panel used in the trap illustrated in FIG. 1.

FIG. 9 is a top view of the control panel illustrated in FIG. 8.

FIG. 10 is a side elevation view of a wall portion of an insect trap which is detachable from a lower bucket portion according to a preferred embodiment of the present invention.

FIG. 11 is a side elevation view of a lower bucket portion of an insect trap which is detachable from the wall portion illustrated in FIG. 10 according to a preferred embodiment of the present invention.

FIG. 12 is a top view of the lower bucket portion illustrated in FIG. 11.

FIG. 13 is a top view of the wall portion illustrated in FIG. 10.

### DETAILED DESCRIPTION OF THE PREFERRED EMBODIMENT

According to a particularly preferred form of the present invention, an insect attractant composition is provided.

The most preferred form of the insect attractant composition includes approximately
2% of C₈ alcohol,
2% of lactic acid C₃H₆O₃,
2% of surfactant
94% water+trace amount of dye.

Any surfactant can be used, but the surfactant in dishwashing detergent for example lowers the surface tension of the water in the composition and allows the components increased miscibility.

The dye (Green Food Colouring) is used to allow the otherwise clear liquid of the composition to be easily seen.

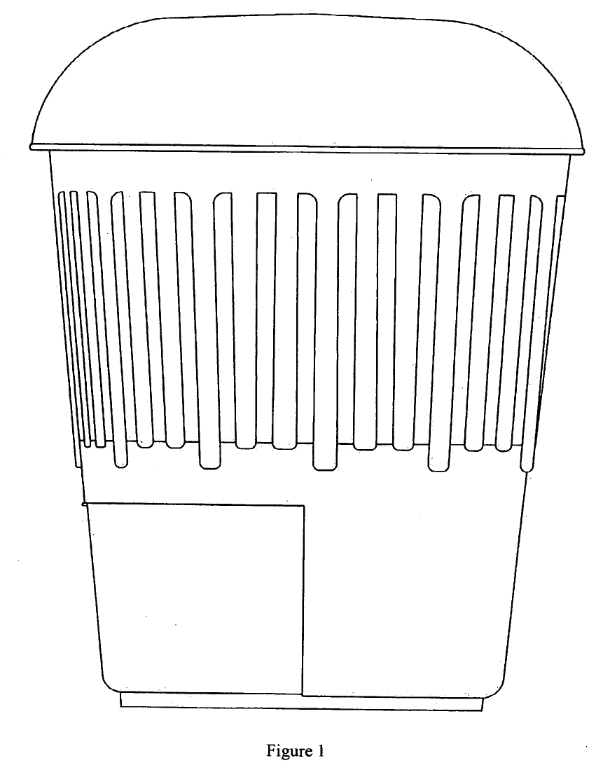

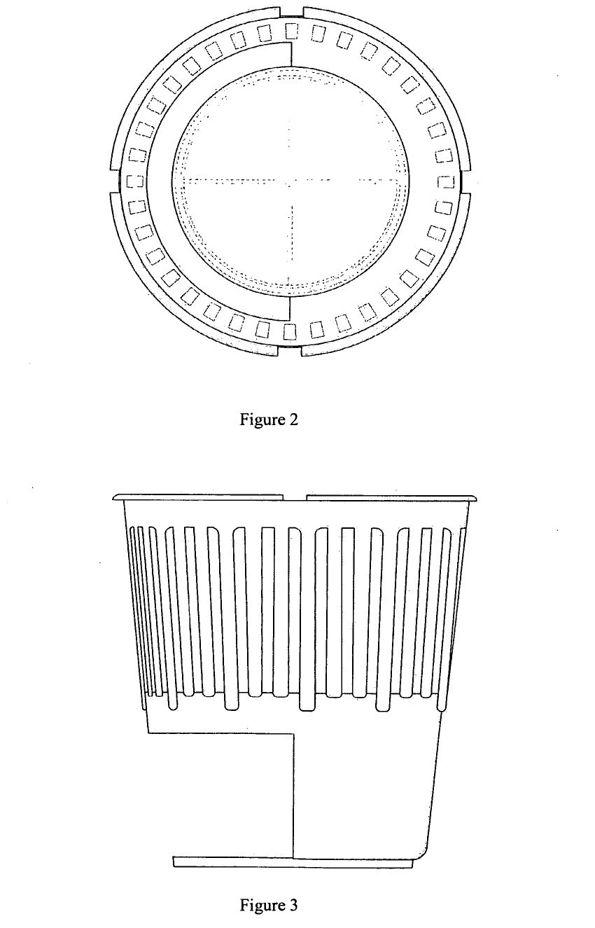

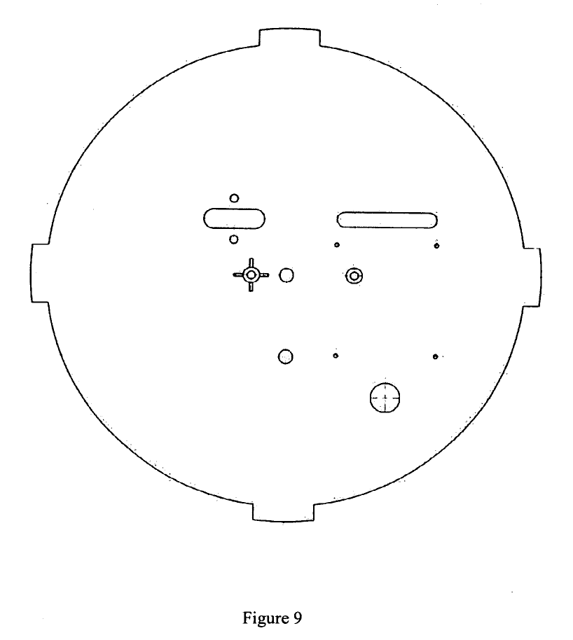

The insect attractant composition is used in an insect trap as illustrated in the FIG. 1 in particular, to attract insects into the trap. The preferred form of trap has a bucket-like configuration. The trap may include multiple attractants including the attractant composition of the invention which together contribute to a controlled environment with in the trap, all of which are generally mounted relative to a control panel illustrated in FIGS. 8 and 9. These other attractants include, for example:
one or more spectrum lights may emit a moving wavelength of light.
UV Light(s)—A blue UV light may be provided to attract most species of mosquitoes. The lights may be provided to flash intermittently.
Colour—The dark colour of the Insect trap may acts as a natural attractant. A particularly preferred colour may be blue or green.
Moisture and Scent—The insect attractant may typically emulate a mammal scent and may produce moisture which replaces the expensive CO₂ gas attractant.
   Once the insects are drawn into the chamber, an in-built fan forces the insects to their death by drowning in the non-toxic environmentally friendly insect attractant liquid.

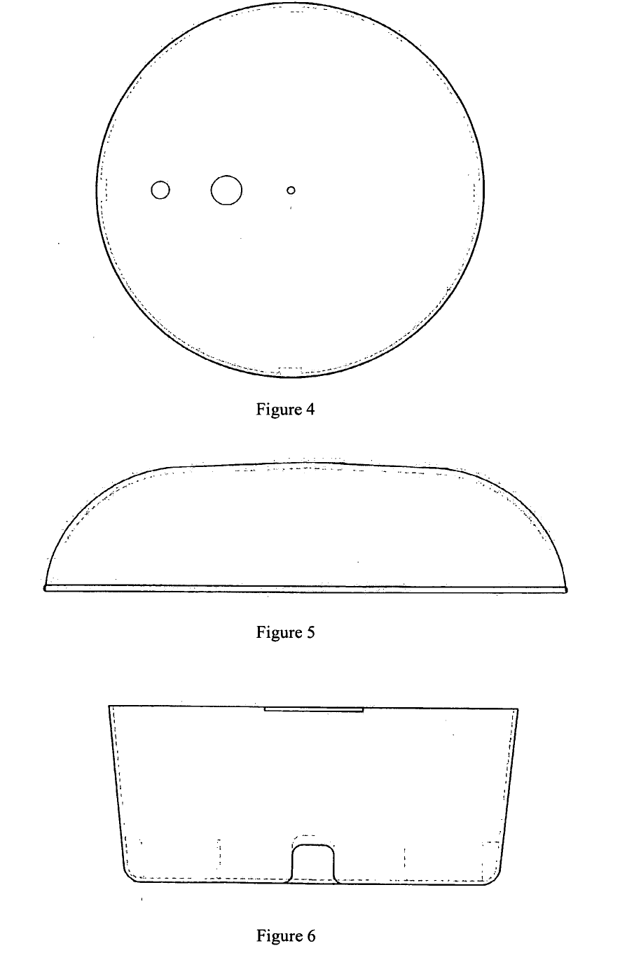

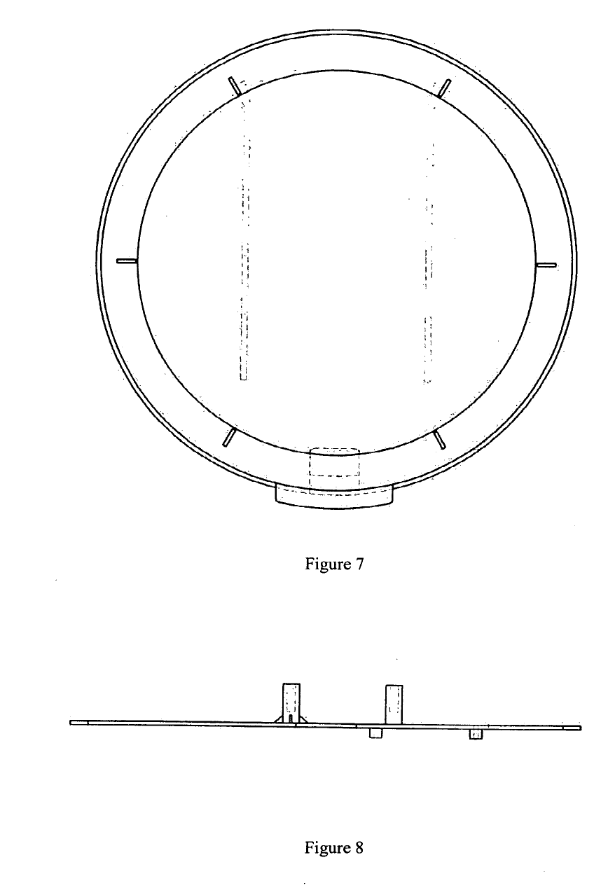

The insect trap will typically be circular, and have a removable portion at a lower portion of the trap to contain the insect attractant. The removable portion can be a drawer as illustrated in FIGS. 6 and 7 or alternatively, an upper annular portion of the trap to which the lid illustrated in FIG. 4 and 5 attaches may be removable from a lower, bucket-like portion.

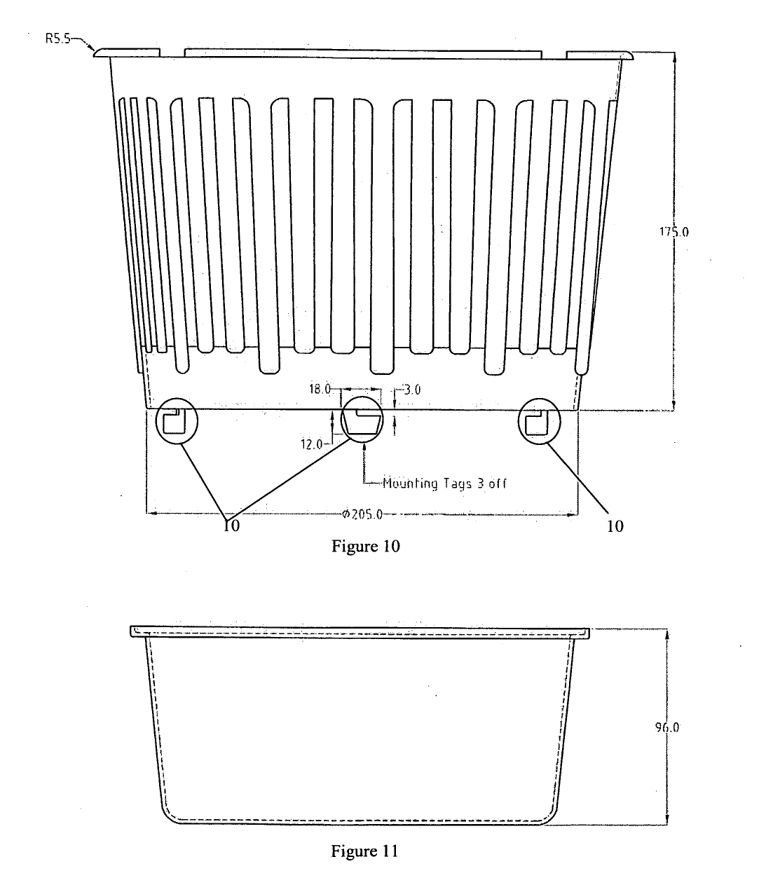

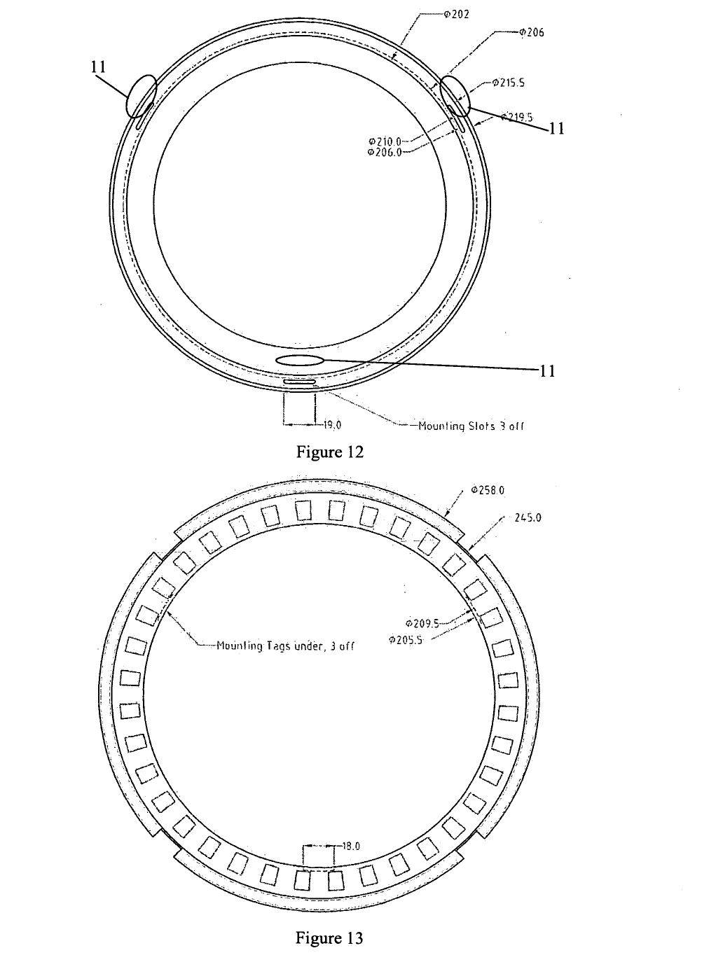

An alternative configuration is illustrated in FIGS. 10 to 13. According to this embodiment, the removable portion is an upper annular portion of the trap (illustrated in FIGS. 10 and 13) to which the lid attaches (an annular sidewall portion) and is removable from the lower, bucket-like portion (illustrated in FIGS. 11 and 12). Mounting tags 10 are provided on the upper annular portion to engage respective openings 11 provided on the lower portion of the trap. The mounting tags 10 detachably lock the upper annular portion of the trap to the lower portion of the trap. The locking action involves the insertion of the mounting tags 10 into the respective openings 11 and partially rotating the upper annular portion relative to the lower portion of the trap.

The trap may also have a removable lid illustrated in FIG. 4 and 5. The side wall of the trap will preferably be provided with multiple openings to allow the insects into the interior of the trap. The openings may take the form of slatted openings.

Examples of the composition have undergone testing at the Vector Control Research Unit School Of Biological Sciences Universiti, Sains, Malaysia, with the following methods and results:

Objective

To investigate the efficacy of the device and composition to attract and kill the following vector mosquitoes:
1. Aedes aegypti—vector of dengue fever/dengue haemorrhagic fever.
2. Culex quinquefasciatus—generally a nuisance mosquito but can transmit urban filariasis and Japanese encephalitis.
   Materials and Method

The device is first placed in the middle of the Peet Grady Chamber, one foot above the floor. Two Petri dishes with sucrose in wet cotton bungs were put into the two corners of the Peet Grady Chamber. A total of 200 female Aedes aegypti or Culex quinquefasciatus were released into the chamber at 0930 h. The device consists of one unit of holding cage, blowing fan and blue light connected to a 240V power supply. 2500 ml of attractant composition according to the preferred embodiment of the invention at the dilution rate of 25 fold was placed in the cage as an attractant. During the test, regularly checks were conducted to ensure that both blue light and blowing fan were working well. The number of mosquitoes killed after targeted exposure period was recorded daily over a number of days. A minimum of 3 replicates for each mosquito species was conducted.

Results and Discussions

Overall 100% and 85% of the female Aedes aegypti and Culex quinquefasciatus, respectively were killed/knockdown by the device.

In the present specification and claims, the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. An insect attractant composition consisting essentially of a short chain carboxylic acid and a short chain alcohol.

2. An insect attractant composition according to claim 1 wherein the the short chain alcohol is octanol or C₈ alcohol and the short chain carboxylic acid is lactic acid or C₃H₆O₃.

3. An insect attractant composition including a short chain carboxylic acid, a short chain alcohol, a surfactant and water.

4. An insect attractant composition according to claim 3 wherein the short chain alcohol is octanol or C₈ alcohol.

5. An insect attractant composition according to either one of claim 3, wherein the short chain carboxylic acid is chosen from the group of carboxylic acids having 1-8 carbon atoms.

6. An insect attractant composition according to claim 3, wherein the short chain carboxylic acid is lactic acid or C₃H₆O₃.

7. An insect attractant composition according to claim 3, wherein the surfactant lowers the surface tension of the water in the composition providing increased miscibility.

8. An insect attractant composition according to claim 3 including 0.01% to 20% of C₄ to C₁₀ alcohol, 0.01% to 20% of C₃H₆O₃, 0.01% to 20% of surfactant and 40% to 99.97% water.

9. An insect attractant composition according to claim 3 including approximately 2% of C₈ alcohol, 2% of lactic acid C₃H₆O₃, 2% of surfactant, 94% water and a trace amount of dye.

10. An insect attractant composition according to claim 1 wherein the composition is further diluted prior to placing the attractant composition into an insect trap.

11. An insect attractant composition according to claim 1 used in a bucket-like configuration a removable portion at a lower portion of the trap to contain the insect attractant, a removable lid, and at least one side wall of the trap is provided with at least one openings to allow the insects into the interior of the trap.
